(19) United States
(12) Patent Application Publication
(10) Pub. No.: US 2017/0205730 A1
(43) Pub. Date: Jul. 20, 2017

(54) EXPOSURE UNIT, IMAGE FORMING UNIT, AND IMAGE FORMING APPARATUS

(71) Applicant: Oki Data Corporation, Tokyo (JP)

(72) Inventor: Taishi KANETO, Tokyo (JP)

(73) Assignee: Oki Data Corporation, Tokyo (JP)

(21) Appl. No.: 15/384,827

(22) Filed: Dec. 20, 2016

(30) Foreign Application Priority Data
Jan. 20, 2016 (JP) 2016-9216

(51) Int. Cl. B41J 2/385

(52) U.S. Cl. CPC G03G 15/04036

(57) ABSTRACT

Provided is an exposure unit that performs exposure of an image supporting member and includes a light-emitting element array, and a lens array. The light-emitting element array includes light-emitting elements that are disposed in a first direction and each emit a light beam. The lens array faces the light-emitting element array in a second direction that is orthogonal to the first direction, and focuses the light beams. The following expressions (1) and (2) are satisfied.

175 μm≦L0−L1≦250 μm (1)

175 μm≦L0−L2≦250 μm (2)

where L0 is a focal distance of the lens array in which a contrast, determined from a light amount distribution in the first direction of any of the light beams focused by the lens array, becomes maximum, and L2 is a distance from the lens array to the image supporting member.

### CROSS REFERENCE TO RELATED APPLICATIONS

This application claims the benefit of Japanese Priority Patent Application JP 2016-009216 filed on Jan. 20, 2016, the entire contents of which are incorporated herein by reference.

### BACKGROUND

The invention relates to an image forming unit that forms an image by an electrophotographic method, to an image forming apparatus provided with the image forming unit, and to an exposure unit that is used in the image forming unit and the image forming apparatus.

Various image forming apparatuses, such as an electronic printer and a facsimile apparatus, that form images by an electrophotographic method each use therein an exposure unit that includes light-emitting elements such as light-emitting diode (LED) elements and a lens array, for example, as disclosed in Japanese Unexamined Patent Application Publication No. 2010-221510.

### SUMMARY

An image forming apparatus provided with an exposure unit may involve a quality issue such as streaks occurred on an image formed by the image forming apparatus, i.e., unevenness of density in a first scanning direction due to streaks extending in a second scanning direction. This issue is attributable to variations in optical characteristics between a plurality of rod lenses included in a lens array.

It is desirable to provide an image forming unit and an image forming apparatus that allow for image formation with improved quality, and an exposure unit that is to be favorably mounted on the image forming unit and the image forming apparatus.

According to one embodiment of the invention, there is provided an exposure unit that performs exposure of an image supporting member. The exposure unit includes a light-emitting element array and a lens array. The light-emitting element array includes a plurality of light-emitting elements that are disposed in a first direction and each emit a light beam. The lens array faces the light-emitting element array in a second direction that is orthogonal to the first direction, and focuses the light beams emitted from the respective light-emitting elements. The following expressions (1) and (2) are satisfied.

175 μm≦L0−L1≦250 μm (1)

175 μm≦L0−L2≦250 μm (2)

In the foregoing expressions (1) and (2), L0 is a focal distance of the lens array in which a contrast becomes maximum. The contrast is determined from a light amount distribution in the first direction of any of the light beams focused by the lens array. L1 is a distance from the lens array to the light-emitting element array. L2 is a distance from the lens array to the image supporting member.

According to one embodiment of the invention, there is provided an image forming unit provided with an exposure unit that performs exposure of an image supporting member. The exposure unit includes a light-emitting element array and a lens array. The light-emitting element array includes a plurality of light-emitting elements that are disposed in a first direction and each emit a light beam. The lens array faces the light-emitting element array in a second direction that is orthogonal to the first direction, and focuses the light beams emitted from the respective light-emitting elements. The following expressions (1) and (2) are satisfied.

175 μm≦L0−L1≦250 μm (1)

175 μm≦L0−L2≦250 μm (2)

In the foregoing expressions (1) and (2), L0 is a focal distance of the lens array in which a contrast becomes maximum. The contrast is determined from a light amount distribution in the first direction of any of the light beams focused by the lens array. L1 is a distance from the lens array to the light-emitting element array. L2 is a distance from the lens array to the image supporting member.

According to one embodiment of the invention, there is provided an image forming apparatus provided with an exposure unit that performs exposure of an image supporting member. The exposure unit includes a light-emitting element array and a lens array. The light-emitting element array includes a plurality of light-emitting elements that are disposed in a first direction and each emit a light beam. The lens array faces the light-emitting element array in a second direction that is orthogonal to the first direction, and focuses the light beams emitted from the respective light-emitting elements. The following expressions (1) and (2) are satisfied.

175 μm≦L0−L1≦250 μm (1)

175 μm≦L0−L2≦250 μm (2)

In the foregoing expressions (1) and (2), L0 is a focal distance of the lens array in which a contrast becomes maximum. The contrast is determined from a light amount distribution in the first direction of any of the light beams focused by the lens array. L1 is a distance from the lens array to the light-emitting element array. L2 is a distance from the lens array to the image supporting member.

### BRIEF DESCRIPTION OF DRAWINGS

FIG. 1 is a perspective view of an overall configuration example of an exposure unit according to one example embodiment of the invention.

FIG. 2 is a side view of the exposure unit illustrated in FIG. 1.

FIG. 3 is an exploded perspective view, in an enlarged manner, of a rod lens illustrated in FIG. 1.

FIG. 4 is a schematic view of an overall configuration example of an image forming apparatus according to one example embodiment of the invention.

FIG. 5 is a characteristic diagram schematically illustrating a process of forming an image by the image forming apparatus illustrated in FIG. 4.

FIG. 6 is a characteristic diagram schematically illustrating an influence, on toner density, derived from a variation in photosensitivity characteristics of an image supporting member in the image forming apparatus illustrated in FIG. 4.

FIG. 7A is a schematic diagram for explaining an exposure intensity distribution of a plurality of light-emitting elements in an exposure unit as a reference example.

FIG. 7B is a schematic diagram for explaining an exposure intensity distribution of a plurality of light-emitting elements in the exposure unit illustrated in FIG. 1.

FIG. 8 is a characteristic diagram illustrating a relationship between exposure intensity and a position and a relationship between the exposure intensity and an optical image diameter in an exposure unit of Example 1.

FIG. 9 is a characteristic diagram illustrating a relationship between exposure intensity and a position and a relationship between the exposure intensity and an optical image diameter in an exposure unit of Example 2.

FIG. 10 is a characteristic diagram illustrating a relationship between exposure intensity and a position and a relationship between the exposure intensity and an optical image diameter in an exposure unit of Example 3.

FIG. 11 is a characteristic diagram illustrating a relationship between exposure intensity and a position and a relationship between the exposure intensity and an optical image diameter in an exposure unit of Example 4.

FIG. 12 is a characteristic diagram illustrating a relationship between exposure intensity and a position and a relationship between the exposure intensity and an optical image diameter in an exposure unit of Example 5.

FIG. 13 is a characteristic diagram illustrating a relationship between exposure intensity and a position and a relationship between the exposure intensity and an optical image diameter in an exposure unit of Example 6.

FIG. 14 is a characteristic diagram illustrating a relationship between exposure intensity and a position and a relationship between the exposure intensity and an optical image diameter in an exposure unit of Example 7.

FIG. 15 is a characteristic diagram illustrating a relationship between exposure intensity and a position and a relationship between the exposure intensity and an optical image diameter in an exposure unit of Example 8.

FIG. 16 is a characteristic diagram illustrating a relationship between exposure intensity and a position and a relationship between the exposure intensity and an optical image diameter in an exposure unit of Example 9.

FIG. 17 is a characteristic diagram illustrating a relationship between exposure intensity and a position and a relationship between the exposure intensity and an optical image diameter in an exposure unit of Example 10.

### DETAILED DESCRIPTION

Some example embodiments of the invention are described below in detail with reference to the drawings. The example embodiments referred to in the description below are mere specific examples of the invention, and the invention is not limited to the example embodiments described below. Arrangements, dimensions, dimension ratios, etc. of components of the invention are not limited to those illustrated in the respective drawings. The description is given in the following order.

1. Example Embodiment

An image forming unit provided with an exposure unit and an image forming apparatus provided with an exposure unit

2. Examples

3. Other Modifications

### 1. Example Embodiment

### [Outline Configuration of Optical Head 1]

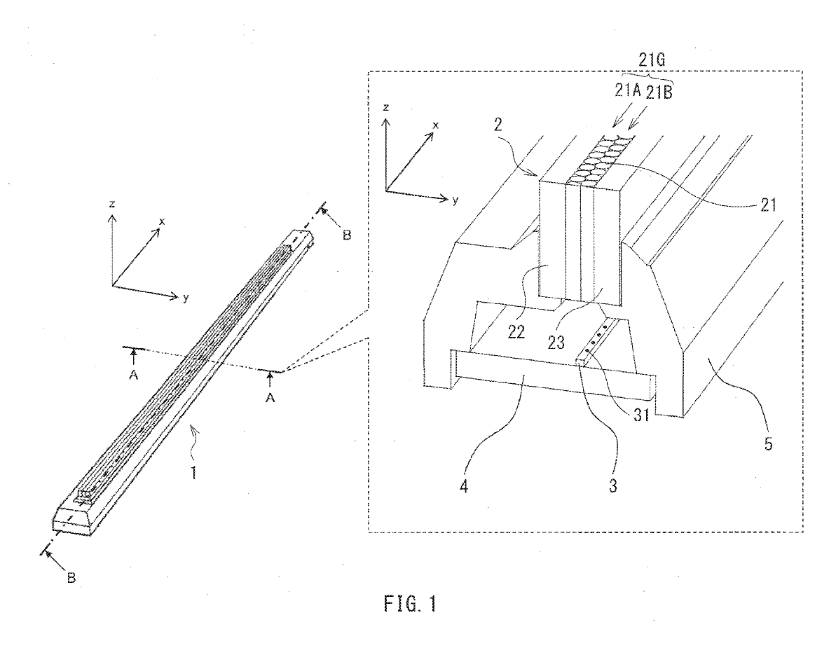

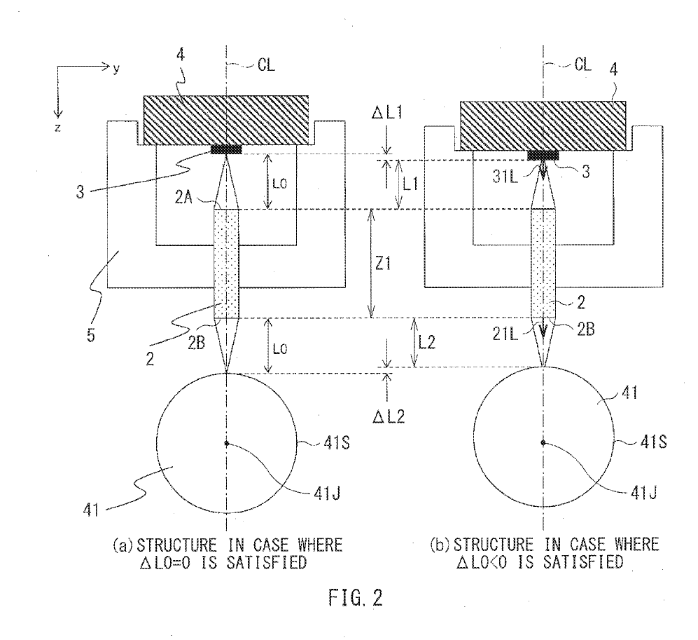

FIG. 1 is a perspective view of an overall configuration example of an optical head 1 according to one example embodiment of the invention. A part surrounded by a dashed line in FIG. 1 illustrates, in an enlarged manner, a structure of a cross-section taken along a line A-A of the optical head 1. FIG. 2 is a cross-sectional view of the optical head 1. The optical head 1 may correspond to an “exposure unit” in one specific but non-limiting embodiment of the invention. The optical head 1 may extend in an X-axis direction, for example. The X-axis direction may correspond to a “first direction” in one specific but non-limiting embodiment of the invention.

The optical head 1 may include a lens array 2, a mounting substrate 4, a light-emitting diode (LED) array 3, and a supporting member 5. The supporting member 5 may support the lens array 2, the mounting substrate 4, and the LED array 3. The lens array 2 may be fixed onto an upper part of the supporting member 5, for example. The LED array 3 may include a plurality of LED elements 31 and be so provided on the mounting substrate 4 as to face one end surface 2A of the lens array 2 illustrated in FIG. 2. The LED elements 31 may be disposed in the X-axis direction and each emit a light beam. The LED array 3 may correspond to a “light-emitting element array” in one specific but non-limiting embodiment of the invention.

The mounting substrate 4 may have two ends in a Y-axis direction that are both fixed onto a lower part of the supporting member 5. The supporting member 5 may support the end surface 2A of the lens array 2 and the LED array 3 with a distance L1 as illustrated in part (b) of FIG. 2. The distance L1 is a distance from the end surface 2A to the LED array 3, which extends in an optical axis direction of the LED elements 31 (a Z-axis direction). It is to be noted that the distance L1 is greater than a focal distance L0 of the lens array 2 by a distance ΔL1 which is smaller than 0 (zero) (ΔL1=L1−L0). The distance ΔL1 may be desirably from −250 μm to −175 μm both inclusive, for example. In other words, it is desirable that the following expression (1) be satisfied.

175 μm≦L0−L1≦250 μm (1)

Referring to the part surrounded by the dashed line in FIG. 1, the lens array 2 may include a lens group 21G and a pair of side plates 22 and 23. The lens group 21G may include a plurality of rod lenses 21 that are bundled together. The pair of side plates 22 and 23 may so face each other as to sandwich, in the Y-axis direction, the lens group 21G in between. The Y-axis direction is a direction that is orthogonal to both the X-axis direction and the Z-axis direction. The lens group 21G may include a first rod lens line 21A and a second rod lens line 21B that are so disposed as to be adjacent to each other in the Y-axis direction, for example. The first rod lens line 21A may include the rod lenses 21 that each have an approximately-cylindrical shape and are disposed in the X-axis direction, for example. Similarly, the second rod lens line 21B may include the rod lenses 21 that each have an approximately-cylindrical shape and are disposed in the X-axis direction. A space between the rod lenses 21 and a space between the rod lenses 21 and the side plates 22 and 23 may be filled with an adhesive agent. The lens array 2 may focus each of the plurality of light beams emitted by the respective LED elements 31, for example, onto a target such as a photosensitive drum 41 described later. In other words, the lens array 2 may concentrate each of the plurality of light beams emitted by the respective LED elements 31, for example, onto the target such as the photosensitive drum 41 described later.

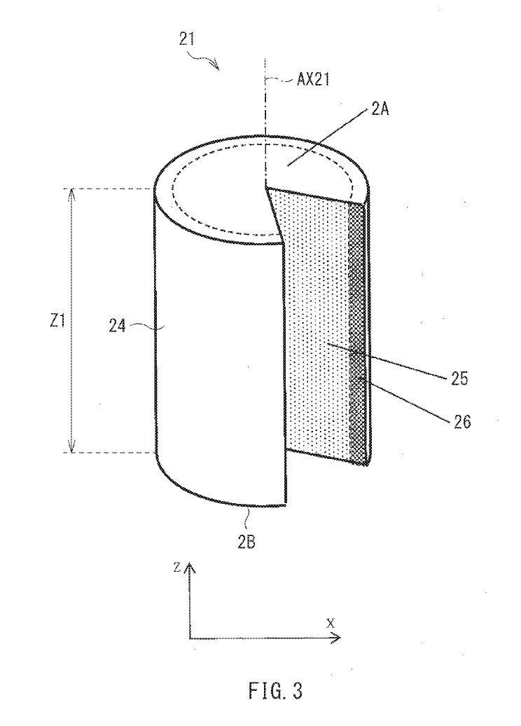

FIG. 3 is a perspective view of a part of an internal structure of the rod lens 21. The rod lens 21 may be a transparent member that has an approximately-cylindrical shape and has a central axis AX21 extending in the Z-axis direction. The rod lens 21 may have a pair of end surfaces 2A and 2B and an outer peripheral surface 24. Light beams may enter and exit from the end surfaces 2A and 2B. The rod lens 21 may include a light absorption layer 26 in the vicinity of the outer peripheral surface 24. The rod lens 21 may also include a lens part 25 on the inner side of the light absorption layer 26. The lens part 25 may have a refractive index distribution in which a refractive index decreases from the outer peripheral surface 24 toward the central axis AX21. The light absorption layer 26 may include a medium having a refractive index almost the same as the refractive index of an outermost portion of the lens part 25 and a light absorbing substance dispersed in the medium, for example. Examples of the light absorbing substance may include a dye and a pigment.

All of the rod lenses 21 and the pair of side plates 22 and 23 that sandwich the rod lenses 21 in between may have the same dimension in the Z-axis direction, which is referred to in this example as a “height Z1”. Accordingly, the dimension of the lens array 2 in the Z-axis direction may also be the height Z1. It is to be noted that the rod lens 21 may preferably have an aperture half-angle that is from about 10° to about 15° both inclusive, preferably have a radius that is from about 0.14 mm to about 0.16 mm both inclusive, preferably have the height Z1 that may be from about 4.2 mm to about 4.4 mm both inclusive, for example, and preferably have the focal distance L0 from about 2.2 mm to about 2.5 mm both inclusive. Examples of a lens applicable to the rod lens 21 may include a Selfoc (registered trademark) lens SLA-12E having an aperture half-angle of 12°. However, the rod lens 21 is not limited to the Selfoc lens SLA-12E.

The optical head 1 may be mounted on an image forming apparatus such as an electronic printer which will be described later, for example. Upon being mounted on the image forming apparatus, the optical head 1 may be so disposed as to face a target to apply light onto such as the photosensitive drum 41 as illustrated in FIG. 2, for example. In such a case, a rotation axis 41J of the photosensitive drum 41 may be preferably located on a line extended from a central position CL, of the optical head 1, that extends in the Y-axis direction. The photosensitive drum 41 may be so disposed that the rotation axis 41J is parallel to the X-axis, for example. Further, it may be preferable that a surface 41S of the photosensitive drum 41 and the end surface 2B of each of the rod lenses 21 included in the lens array 2 be so supported to have a spacing of a distance L2 that extends at the central position CL of the optical head 1. The distance L2 is greater than the focal distance L0 by a distance ΔL2 that is smaller than 0 (zero) (ΔL2=L2−L0). The distance ΔL2 may preferably coincide with the distance ΔL1. In other words, the distance L2 may preferably coincide with the distance L1. Accordingly, it may be desirable that the following expression (2) be satisfied.

175 μm≦L0−L2≦250 μm (2)

The LED array 3 in the optical head 1 may have resolution of 600 dpi or 1200 dpi, for example. When the LED array 3 has the resolution of 600 dpi, six-hundred LED elements 31 are provided per 1 inch (equals to about 25.4 mm). In other words, the LED elements 31 have an arrangement pitch of about 0.04233 mm. When the LED array 3 has the resolution of 1200 dpi, one-thousand-and-two-hundred LED elements 31 are provided per 1 inch. In other words, the LED elements 31 have an arrangement pitch of about 0.021167 mm. Further, the LED element 31 may preferably have a light-emission central wavelength that is from about 740 mm to about 780 mm both inclusive, for example.

### [Outline Configuration of Image Forming Apparatus 100]

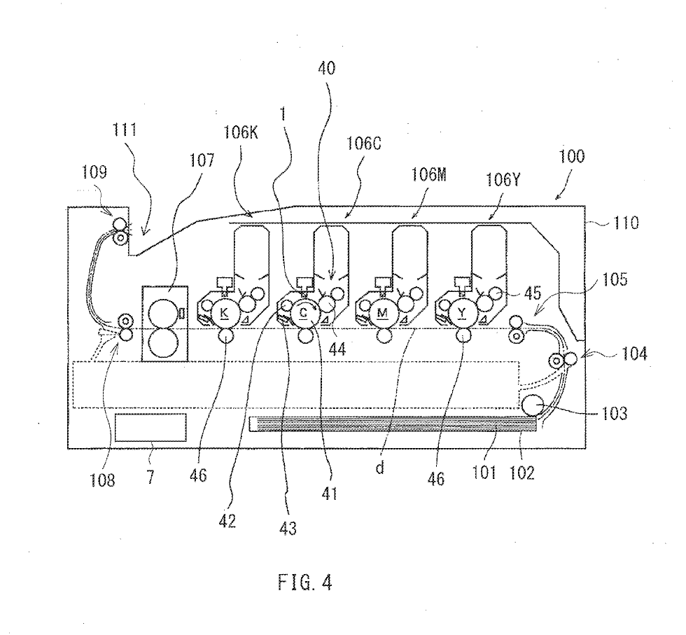

FIG. 4 is a schematic view of an overall configuration example of an image forming apparatus 100 provided with the foregoing optical head 1. The image forming apparatus 100 may be a printer using an electrophotographic method that forms an image on a medium 101. The image may be a color image, for example. The medium 101 may be also referred to as a print medium or a transfer member. Examples of the medium 101 may include a sheet and a film. The image forming apparatus 100 may correspond to an “image forming apparatus” in one specific but non-limiting embodiment of the invention.

Referring to FIG. 4, the image forming apparatus 100 may include a medium feeding cassette 102, a medium feeding roller (a hopping roller) 103, a conveying roller pair 104, a conveying roller pair 105, four image forming units (processing units) 106Y, 106M, 106C, and 106K, and a fixing unit 107, a discharging roller pair 108, and a discharging roller pair 109 that are disposed in order from the upstream to the downstream inside a housing 110, for example. A stacker 111 may be provided at an upper part of the housing 110. Further, the image forming apparatus 100 may be provided with an external interface unit built therein and a controller 7. The external interface unit may receive print data from an external apparatus such as a personal computer (PC). The controller 7 may perform overall operation control of the image forming apparatus 100.

The medium feeding cassette 102 may be a member that contains the media 101 in a stacked state. The medium feeding cassette 102 may be provided attachably and detachably at a lower part of the image forming apparatus 100, for example.

The medium feeding roller 103 may be a member that picks up the media 101 separately one by one from the top of the media 101 contained in the medium feeding cassette 102, and feeds the medium 101 picked up toward the conveying roller pair 104. In other words, the medium feeding roller 103 may be a medium feeding mechanism.

Each of the conveying roller pair 104 and the conveying roller pair 5 may be a member that sequentially sandwiches the medium 101 fed from the medium feeding roller 103 and convey the medium 101 toward the image forming units 106Y, 106M, 106C, and 106K while aligning properly the medium 101 that has been fed obliquely.

The image forming units 106Y, 106M, 106C, and 106K may be disposed in order from the upstream to the downstream along a conveying path “d” of the medium 101 illustrated by a dashed line in FIG. 4. It is to be noted that the conveying path “d” may be a path having a shape of a letter “S” as a whole in this example as illustrated in FIG. 4. The image forming units 106Y, 106M, 106C, and 106K may each correspond to an “image forming unit” in one specific but non-limiting embodiment of the invention.

The respective image forming units 106Y, 106M, 106C, and 106K may form images (toner images) on the medium 101 using different colors of toner (developers). More specifically, the image forming unit 106Y may form a yellow toner image using yellow (Y) toner. Similarly, the image forming unit 106M may form a magenta toner image using magenta (M) toner. Similarly, the image forming unit 106C may form a cyan toner image using cyan (C) toner. Similarly, the image forming unit 106K may form a black toner image using black (K) toner.

The foregoing toner of each of the colors may include agents such as a predetermined coloring agent, a predetermined release agent, a predetermined electric charge control agent, and a predetermined treatment agent, for example. Components of the respective agents described above may be mixed as appropriate or subjected to a surface treatment to produce the toner. The coloring agent, the release agent, and the electric charge control agent out of the foregoing agents may serve as internal additives. Further, an additive such as silica and titanium oxide may be included as an external additive, and a resin such as polyester resin may be included as a binding resin. As the coloring agent, an agent such as a dye and a pigment may be used solely, or a plurality of agents such as a dye and a pigment may be used in combination.

The image forming units 106Y, 106M, 106C, and 106K may have the same configuration except that the colors of the toner used to form the toner images (the developer images) are different from each other as described above. Hence, the image forming units 106Y, 106M, 106C, and 106K may be collectively referred to as an “image forming unit 106” below to describe the structure, etc. thereof.

Referring to FIG. 4, the image forming unit 106 may include a toner cartridge 40 (a developer container), the photosensitive drum 41 (an image supporting member), an electrically-charging roller 43 (an electrically-charging member), a developing roller 44 (a developer supporting member), a feeding roller 45 (a feeding member), a cleaning blade 43, the optical head 1, and a transfer roller 46.

The toner cartridge 40 may be a container that contains the foregoing toner of each of the colors. More specifically, the toner cartridge 40 in the image forming unit 106Y may contain therein the yellow toner. The toner cartridge 40 in the image forming unit 106M may contain therein the magenta toner. The toner cartridge 40 in the image forming unit 106C may contain therein the cyan toner. The toner cartridge 40 in the image forming unit 106K may contain therein the black toner.

The photosensitive drum 41 may be a member that has a surface (a surficial part) supporting an electrostatic latent image thereon. The photosensitive drum 41 may include a photosensitive body such as an organic photosensitive body. More specifically, the photosensitive drum 41 may include an electrically-conductive supporting body and a photoconductive layer that covers an outer periphery (a surface) of the electrically-conductive supporting body. The electrically-conductive supporting body may include a metal pipe made of aluminum, for example. The photoconductive layer may have a structure including an electric charge generation layer and an electric charge transfer layer that are stacked in order, for example. It is to be noted that the foregoing photosensitive drum 41 may rotate at a predetermined peripheral velocity.

The electrically-charging roller 42 may be a member that electrically charges the surface 41S of the photosensitive drum 41. The electrically-charging roller 42 may be so disposed to be in contact with the surface 41S of the photosensitive drum 41. The electrically-charging roller 42 may include a metal shaft and an electrically-semiconductive rubber layer that covers an outer periphery (a surface) of the metal shaft, for example. The electrically-semiconductive rubber layer may be an electrically-semiconductive epichlorohydrin rubber layer, for example. It is to be noted that the electrically-charging roller 42 may rotate in a direction opposite to the rotation direction of the photosensitive drum 41, for example.

The developing roller 44 may be a member that has a surface supporting thereon toner to develop the electrostatic latent image. The developing roller 44 may be so disposed as to be in contact with a surface (a peripheral surface) of the photosensitive drum 41. The developing roller 44 may include a metal shaft and an electrically-semiconductive urethane rubber layer that covers an outer periphery (a surface) of the metal shaft. It is to be noted that the foregoing developing roller 44 may rotate in a direction opposite to the rotation direction of the photosensitive drum 41, for example.

The feeding roller 45 may be a member that feeds the toner contained inside the toner cartridge 40 to the developing roller 44. The feeding roller 45 may be so disposed as to be in contact with a surface (a peripheral surface) of the developing roller 44. The feeding roller 45 may include a metal shaft and a foamable silicone rubber layer that covers an outer periphery (a surface) of the metal shaft, for example. It is to be noted that the feeding roller 45 may rotate in a direction same as the rotation direction of the developing roller 44, for example.

The cleaning blade 43 may be a member that scrapes the toner remained on the surface (the surficial part) of the photosensitive drum 41 to thereby remove the remained toner from the surface of the photosensitive drum 41. In other words, the cleaning blade 43 may be a member that cleans the surface of the photosensitive drum 41. The cleaning blade 43 may be so disposed as to be in contact with the surface of the photosensitive drum 41 in a counter direction. In other words, the cleaning blade 43 may be so disposed as to protrude in a direction opposite to the rotation direction of the photosensitive drum 41. The cleaning blade 43 may be made of an elastic material such as polyurethane rubber.

The optical head 1 may be the one described above. The optical head 1 may be a unit that selectively applies application light onto the surface 41S of the photosensitive drum 41 that has been electrically charged by the electrically-charging roller 42, on the basis of the image data. The optical head 1 may thus expose the surface 41S of the photosensitive drum 41, and thereby form an electrostatic latent image on the surface 41S (the surficial part) of the photosensitive drum 41. The optical head 1 may be supported by the housing 110, for example.

The transfer roller 46 may be a member that electrostatically transfers, on the medium 101, the toner image formed inside each of the image forming units 106Y, 106M, 106C, and 106K. The transfer roller 46 may be so disposed as to face each of the photosensitive drums 41 in the respective image forming units 106Y, 106M, 106C, and 106K. It is to be noted that the transfer roller 46 may be made of foamable electrically-semiconductive elastic rubber material, for example.

The fixing unit 107 may be a unit that applies heat and pressure to the toner (the toner image) on the medium 101 conveyed from the image forming unit 106, and thereby fixes the toner image onto the medium 101. The fixing unit 107 may include a heating unit and a pressurizing roller that are so disposed as to face each other with the conveying path “d” of the medium 101 in between, for example. It is to be noted that the fixing unit 107 may be provided integrally with the image forming apparatus 100, or may be attachably and detachably attached to the image forming apparatus 100, for example.

The discharging roller pair 108 and the discharging roller pair 109 may each be a guiding member that guides the medium 101 when the medium 101 onto which the toner is fixed by the fixing unit 107 is discharged to outside of the image forming apparatus 100. The medium 101 that has been guided by the discharging roller pair 108 and the discharging roller pair 109 in order and discharged to the outside of the housing 110 may be discharged, in a face-down state, toward the stacker 111 provided at the upper part of the housing 110. It is to be noted that the stacker 111 may be a part in which the media 101 each provided with an image formed (printed) thereon are accumulated.

### [Operation and Workings]

### (A. Basic Operation)

The image forming apparatus 100 may have a configuration in which the toner image is transferred onto the medium 101 in the following manner. In other words, the image forming apparatus 100 may have a configuration in which printing operation is performed in the following manner.

When the print image data and printing order are supplied from an external device such as a PC to the controller 7 in the image forming apparatus 100 in an operating state, the controller 7 may start the printing operation of the print image data according to the printing order.

For example, referring to FIG. 4, the media 101 contained in the medium feeding cassette 102 may be picked up one by one from the top by the medium feeding roller 103. The medium 101 picked up may be conveyed by members such as the conveying roller pair 104 and the conveying roller pair 105 while the medium 101 that has been obliquely fed is aligned properly by the members such as conveying roller pair 104 and the conveying roller pair 105. The medium 101 may be thus conveyed to the image forming units 106Y, 106M, 106C, and 106K provided downstream from the conveying roller pair 104 and the conveying roller pair 105. The toner image may be transferred onto the medium 101 in the following manner in each of the image forming units 106Y, 106M, 106C, and 106K.

In each of the image forming units 106Y, 106M, 106C, and 106K, the toner image of each of the colors may be formed through the following electrophotographic process according to the printing order given by the controller 7. More specifically, the controller 7 may start a driver to cause the photosensitive drum 41 to rotate in the predetermined rotation direction at a constant velocity. In accordance with the rotation of the photosensitive drum 41, the members such as the electrically-charging roller 42, the developing roller 44, and the feeding roller 45 may start rotation operation in the predetermined direction.

The controller 7 may apply a predetermined voltage to the electrically-charging roller 42 for each of the colors, to thereby electrically charge the surface of the photosensitive drum 41 for each of the colors uniformly. Thereafter, the controller 7 may supply a control signal to the optical head 1 to thereby start the optical head 1. The started optical head 1 may apply light beams corresponding to the respective color components of the print image based on the image data onto the respective photosensitive drums 41 of the respective colors, thereby forming the electrostatic latent images on the surfaces 41S of the photosensitive drums 41 for the respective colors. More specifically, each of the LED elements 31 may emit a light beam having a predetermined light amount on the basis of the control signal supplied from the controller 7. A light beam 31L emitted from each of the LED elements 31 may enter the lens array 2. The light beam 31L that has entered the lens array 2 may exit thereafter from the lens array 2 as a light beam 21L to be focused on the surface 41S of the photosensitive drum 41, as illustrated in part (b) of FIG. 2.

The toner contained inside the toner cartridge 40 may be fed to the developing roller 44 via the feeding roller 45. The fed toner may be supported by the surface of the developing roller 44. The developing roller 44 may attach the toner to the electrostatic latent image formed on the photosensitive drum 41 to thereby form the toner image. Further, the transfer roller 46 may receive a voltage, leading to generation of an electric field between the photosensitive drum 41 and the transfer roller 46. When the medium 101 is passed between the photosensitive drum 41 and the transfer roller 46 in such a state, the toner image formed on the photosensitive drum 41 may be transferred onto the medium 101.

Thereafter, the toner images on the medium 101 may be applied with heat and pressure by the fixing unit 107, to be thereby fixed onto the medium 101. Finally, the medium 101 onto which the toner images are fixed may be discharged to the outside of the housing 110 by the discharging roller pair 108 and the discharging roller pair 109. The discharged medium 101 may be stocked in the stacker 111. This may bring the printing operation performed on the medium 101 to the end.

### (B. Workings of Optical Head 1)

The optical head 1 may have a configuration in which, upon application of a voltage to each of the LED elements 31 in the LED array 3, the LED elements 31 each emit the light beam 31L having predetermined intensity in accordance with the applied voltage. Referring to part (b) of FIG. 2, each of the light beams 31L emitted by the respective LED elements 31 may enter the rod lens 21 through the end surface 2A. Each of the light beams 31L entered the rod lens 21 may be focused by the rod lens 21 and exit from the end surface 2B as the light beam 21L. The light beam 21L exited from the end surface 2B may travel directly toward to a target of the exposure such as the photosensitive drum 41.

Configuring the rod lens 21 in the optical head 1 of a lens having a relatively-small aperture half-angle from about 10° to about 15° both inclusive may allow the rod lens 21 to have relatively-high resolving power. Therefore, variations in intensity distribution of the optical image formed on the surface 41S of the photosensitive drum 41 in correspondence with each of the LED elements 31 may occur more easily in the foregoing case where the rod lens 21 is configured of the lens having the relatively-small aperture half-angle than in a case where the rod lens 21 is configured of a lens having a relatively-large aperture half-angle. One reason for this is that a decrease in the aperture half-angle of the rod lens 21 may cause the intensity distribution of the optical image generated on the surface 41S to be more easily influenced by factors such as the structure of the surface of the LED element 31, and variations in a light amount, the light-emitting area, and luminous intensity distribution characteristics between the LED elements 31 included in the LED array 3. Hence, exposure is generally performed in a state in which the factors such as the light amount are corrected in order to improve printing quality.

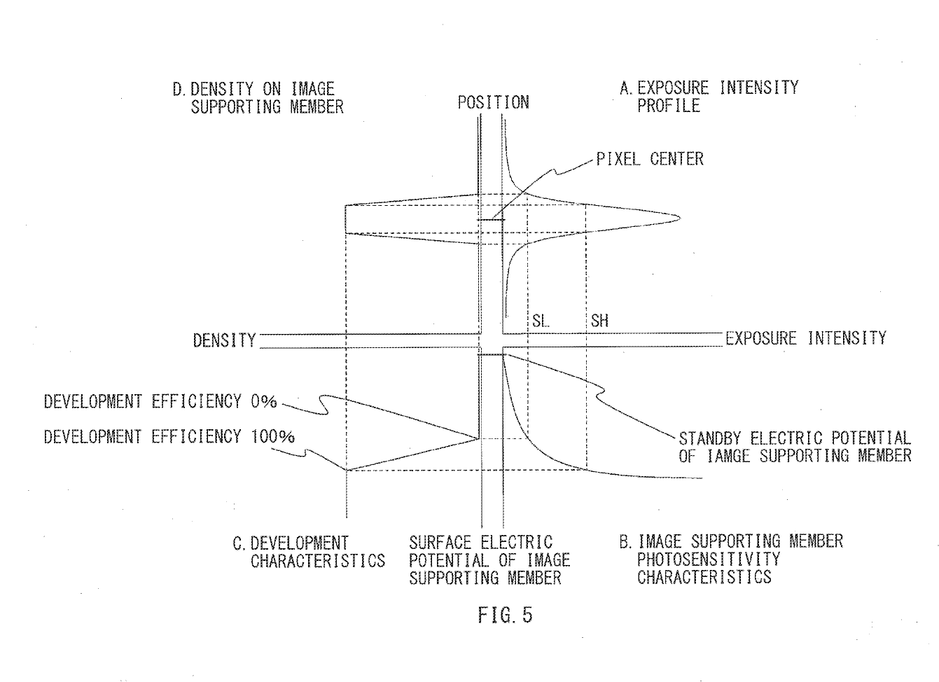

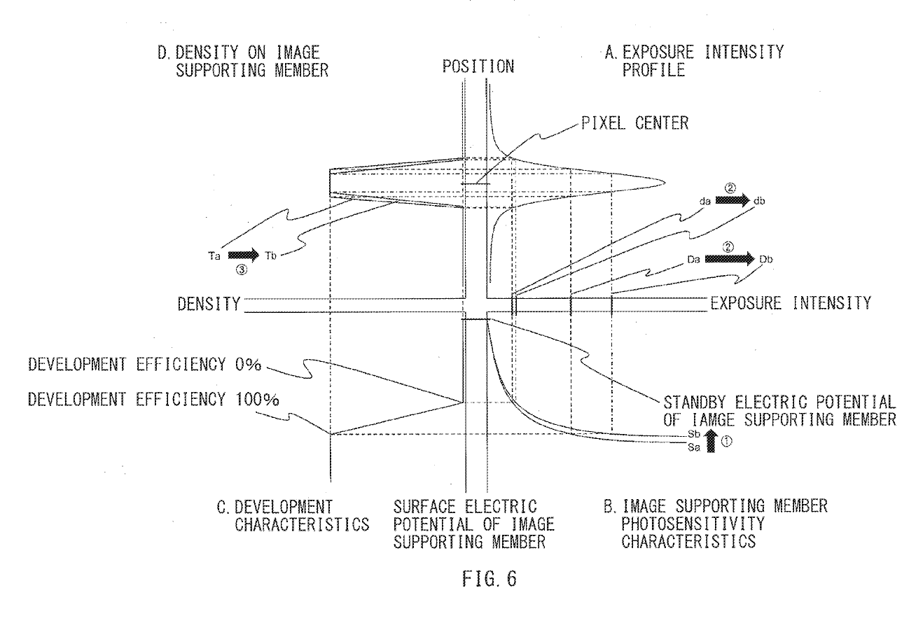

However, printing quality of the image forming apparatus 100 using an electrophotographic method may also depend on development characteristics derived from characteristics such as photosensitivity characteristics of the photosensitive drum 41 and electric charge characteristics of the toners, besides the characteristics of the optical head 1. Various characteristics such as the photosensitivity characteristics of the photosensitive drum 41 and the electric charge characteristics of the toner generally involve variations. The foregoing various characteristics may also vary depending on a state of use of the photosensitive drum 41. For example, it is known that the photosensitivity characteristics of the photosensitive drum 41 vary depending on a temperature and humidity of an environment of its use, that the photosensitivity characteristics of the photosensitive drum 41 temporarily vary when used continuously for exposure, and that the photosensitivity characteristics of the photosensitive drum 41 vary due to a reduction in thickness of a photosensitive layer of the photosensitive drum 41 in accordance with the use of the photosensitive drum 41. Further, it is known that the characteristics such as the electric charge characteristics of the toner vary depending on factors such as a temperature and humidity of the environment, and mechanical friction that occurs between each of rotating members such as the rollers related to the image forming process. The influence of the foregoing variation in characteristics may not be avoided sufficiently in some cases even the factors such as the light amount of the optical head 1 are corrected. In such a case, the foregoing variation in characteristics may influence the printing quality. This is described below with reference to FIGS. 5 and 6.

FIG. 5 is a graph schematically illustrating a process of forming the toner image on the photosensitive drum 41 serving as the image supporting member in the image forming apparatus 100.

A region A in the upper-right part of FIG. 5 includes schematic illustration of a relationship between a position on the surface 41S of the photosensitive drum 41 and intensity of the light beam 21L illustrated in part (b) of FIG. 2 that is applied onto the surface 41S, i.e., exposure intensity. Referring to the region A of FIG. 5, the exposure intensity is highest at a position facing the central position of the LED element 31, and the exposure intensity decreases in accordance with an increase in distance from the central position of the LED element 31.

A region B in the lower-right part of FIG. 5 includes schematic illustration of a relationship between a surface electric potential on the surface 41S of the photosensitive drum 41 and the exposure intensity. Referring to the region B of FIG. 5, an increase in the exposure intensity with respect to the photosensitive drum 41 leads to a gradual increase in the surface electric potential of the photosensitive drum 41 from an electric potential in a standby state of the photosensitive drum 41. It is to be noted that the surface 41S is applied with a predetermined standby electric potential also in a state without being exposed (in a standby state).

A region C in the lower-left part of FIG. 5 illustrates development characteristics. More specifically, the region C of FIG. 5 includes schematic illustration of a relationship between the surface electric potential on the surface 41S and density of the toner in the toner image supported by the surface 41S. Referring to the region C of the FIG. 5, development efficiency varies from 0% to 100% depending on a value of the exposure intensity. In other words, development is performed between a lower limit value SL of the exposure intensity corresponding to the development efficiency of 0% and an upper limit value SH of the exposure intensity corresponding to the development efficiency of 100%. The development efficiency 0% refers to a state in which no toner is attached onto the surface 41S, i.e., a state in which the density of the toner in the toner image is lowest. Further, the development efficiency 100% refers to a state in which the toner image is formed with the maximum thickness in the image forming process, i.e., a state in which the density of the toner in the toner image is highest.

A region D in the upper-left part of FIG. 5 includes schematic illustration of variation in density of the toner in the toner image on the surface 41S. More specifically, the region D of FIG. 5 includes schematic illustration of a relationship between the position on the surface 41S and the density of the toner in the toner image supported by the surface 41S. Referring to the region D of FIG. 5, the density of the toner is highest at the position facing the central position of the LED element 31. A gradual decrease in density of the toner begins from positions corresponding to the upper limit SH of the exposure intensity illustrated in the region A of FIG. 5 in accordance with an increase in distance from the central position of the LED element 31.

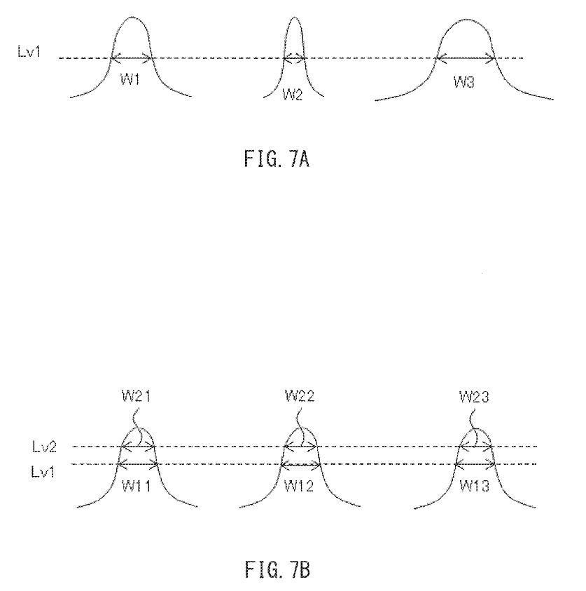

FIG. 6 includes schematic illustration of an influence, on the density of the toner, derived from the variation in the photosensitivity characteristics of the photosensitive drum 41. To give an example, a description is given below of an example case in which the photosensitivity of the photosensitive drum 41 is decreased, i.e., a case in which the amount of the variation in the surface electric potential from the standby electric potential is decreased under the condition of the same exposure intensity. A region B in the lower-right part of FIG. 6 illustrates a state in which the photosensitivity characteristics of the photosensitive drum 41 vary from a curve Sa to a curve Sb. Upon the foregoing variation in the photosensitivity characteristics of the photosensitive drum 41, the exposure intensity of the optical head 1 corresponding to certain development efficiency in the development characteristics illustrated in the region C in the lower-left part of FIG. 6 varies. For example, the exposure intensity corresponding to the development efficiency of 100% increases from Da to Db, and the exposure intensity corresponding to the development efficiency of 0% increases from da to db, referring to the regions A, B, and C of FIG. 6. As a result, an optical image diameter that satisfies the exposure intensity sufficient for development also varies, which leads to variation in the density of the toner on the photosensitive drum 41 from Ta to Tb, referring to a region D of FIG. 6. As described above, the respective LED elements 31 in the LED array 3 included in the optical head 1 involve variations in factors such as the light amount, the light-emitting area, and the luminous intensity distribution. Hence, the respective LED elements 31 are used in a state in which the factors such as the light amount are corrected. Such correction is made assuming that the respective LED elements 31 are to be used in a range that allows the photosensitive drum 41 to satisfy predetermined photosensitivity characteristics and development characteristics. In the example illustrated in FIG. 6, for example, it is assumed that the range of the exposure intensity that contributes to development is from the exposure intensity Da to the exposure intensity da illustrated in the region A. Accordingly, it may be reasonable to aim to decrease variations in optical image diameter between the LED elements 31 in a range from the exposure intensity Da to the exposure intensity da, in order to improve evenness of the respective pixels in the formed image by correcting the factors such as the light amount in the respective LED elements 31 included in the optical head 1. One reason for this is that streaky unevenness occurs on the formed image when the optical image diameters W1 to W3 of the LED elements 31 disposed side by side in the X-axis direction largely differ from each other, even with approximately the same level of the exposure intensity (level Lv1), as illustrated in FIG. 7A, for example. FIG. 7A includes schematic illustration of a relationship between exposure intensity of respective LED elements included in an LED array and a position in a light-emitting surface (an exposure intensity distribution) as a reference example.

However, in a case where the photosensitivity characteristics of the photosensitive drum 41 vary as illustrated in FIG. 6 (in a case where the photosensitivity characteristics of the photosensitive drum 41 vary from the curve Sa to the curve Sb), the higher range that is from the exposure intensity Db to the exposure intensity db contributes to development. Further, evenness of the optical image diameter between the LED elements 31 is also expected in the foregoing range. It is to be noted that FIG. 6 illustrates the example case where the photosensitivity characteristics of the photosensitive drum 41 vary. However, a similar argument is also applicable to cases such as a case in which the development characteristics (the development efficiency illustrated in the region C) vary, and a case in which the photosensitivity characteristics of the photosensitive drum 41 and the development characteristics vary at the same time. Accordingly, a decrease in variations in optical image diameter between the LED elements 31 may be preferable also in a case in which light having the exposure intensity outside of the presumed favorable range of exposure intensity derived from the photosensitivity characteristics of the photosensitive drum 41 and the development characteristics contributes to the development.

### [Effects]

Accordingly, the arrangement of the LED array 3, the lens array 2, and the photosensitive drum 41 is so set as to satisfy the expressions (1) and (2) as described above in the present example embodiment. As illustrated in FIG. 7B, this allows the LED elements 31 disposed in the X-axis direction to have exposure intensity distributions that are similar to each other. This suppresses variations in optical image diameter between the LED elements 31 under the exposure intensity to be used (of level Lv1) (W11≈W12≈W13). Even in a case where the exposure intensity to be provided for the exposure varies from level Lv1 to level Lv2, the LED elements 31 have the exposure intensity distributions similar to each other. This suppresses variations in optical image diameter (W21≈W22≈W23). In other words, the optical head 1 performs exposure on the photosensitive drum 41 using the exposure intensity in a range causing less variation in optical image diameter. This reduces streaks, unevenness of density, etc. of the formed image. According to the image forming apparatus 100 provided with the foregoing optical head 1, it is therefore possible to perform appropriate exposure and to form an image having higher quality.

### 2. Examples

### Example 1

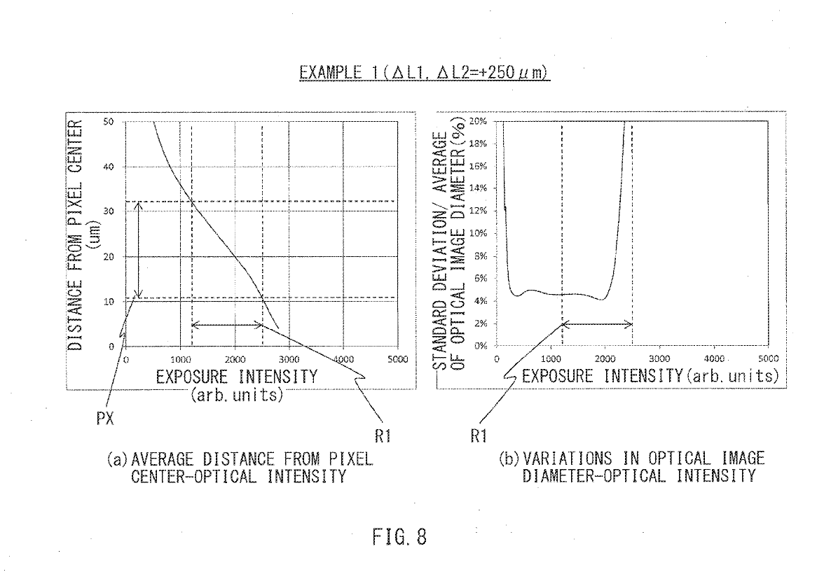

The optical head 1 described above referring to the example embodiment was fabricated to examine the exposure intensity distribution in the X-axis direction of the LED elements 31 and the relationship between the exposure intensity and the optical image diameter of the LED elements 31. FIG. 8 illustrates results of the examination. In this Example, a Selfoc (registered trademark) lens SLA-12E having an aperture half-angle of 12° available from Nippon Sheet Glass Co., Ltd located in Tokyo, Japan was used as the rod lens 21. The LED array 3 had resolution of 1200 dpi corresponding to A4 size. The LED element 31 had a light emission wavelength having a central value within 740 mm to 780 mm both inclusive. The rod lenses 21 each had a radius from 0.14 mm to 0.16 mm both inclusive. The rod lenses 21 had characteristics in a refractive index distribution that were almost the same as each other. Further, the lens array 2 had the height Z1 of 4.36 mm, and the focal distance L0 of 2.38. Further, the distance ΔL1 and the distance ΔL2 were both set as +250 μm. In other words, the distances L1 and L2 were each set to be greater than the focal distance L0 (=2.38 mm) by 250 μm.

Part (a) of FIG. 8 includes a graph having a vertical axis that indicates a distance from the pixel center (the center of the LED element 31 in the X-axis direction), and a horizontal axis that indicates exposure intensity, on the surface 41S, of the light beam applied onto the surface 41S from the LED element 31. Part (b) of FIG. 8 includes a graph having a vertical axis that indicates variations in optical image diameter between the LED elements 31 (a ratio of standard deviation to the average) and a horizontal axis that indicates the exposure intensity as with that in part (a) of FIG. 8. Concerning the variations in optical image diameter, the term “average” refers to the average in all of the pixels (all of the LED elements 31) in the optical head 1, and the term “variations” refers to a value of the standard deviation of all of the pixels (all of the LED elements 31) in the optical head 1 divided by the average of all of the LED elements 31 in the optical head 1. In FIG. 8, a range denoted with PX is a range of a position, in the X-axis direction, of a LED element 31 that is adjacent to the LED element 31 emitting a light beam, from the center of the LED element 31 emitting the light beam. In this Example, the range PX specifically refers to a range that is away from the center of the LED element 31 emitting the light beam by a distance from 10.6 μm to 31.8 μm both inclusive. Further, a range denoted with R1 in FIG. 8 indicates a range of exposure intensity of the light beam applied onto the LED element 31 adjacent to the LED element 31 emitting the light beam, out of the light beam emitted from the LED element 31 emitting the light beam.

As illustrated in part (b) of FIG. 8, the optical image diameter largely varied in the exposure intensity range R1 as the result of the present Example. Further, image formation (printing) was performed by the image forming apparatus 100 provided with the optical head 1 of the present Example. As a result, streaks and unevenness of density were confirmed on the printed image.

### Example 2

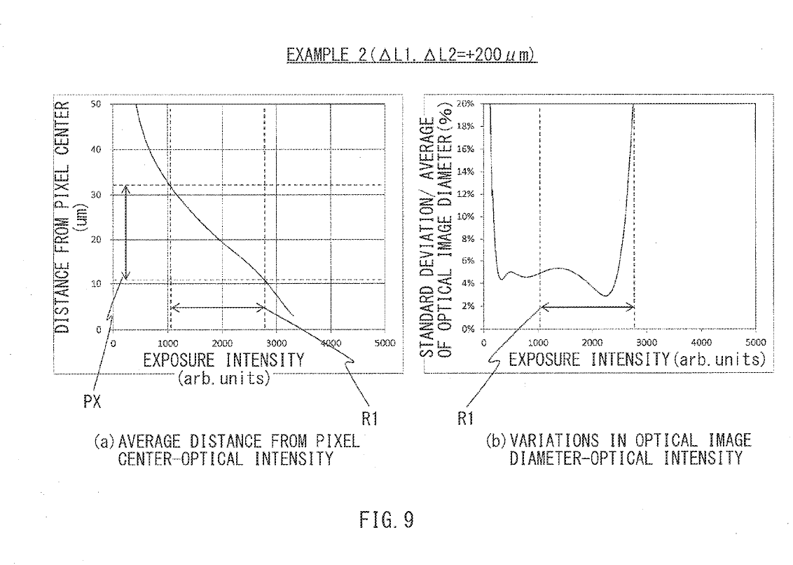

The distances ΔL1 and ΔL2 were both set as +200 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 9 illustrates results of the examination. As illustrated in part (b) of FIG. 9, the optical image diameter largely varied in the exposure intensity range R1 as the result of the present Example. Further, image formation (printing) was performed by the image forming apparatus 100 provided with the optical head 1 of the present Example. As a result, streaks and unevenness of density were confirmed on the printed image.

### Example 3

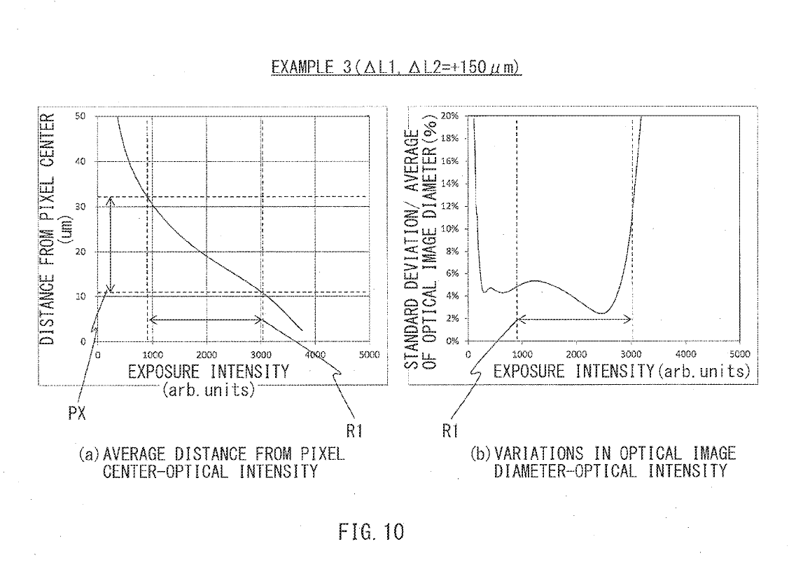

The distances ΔL1 and ΔL2 were both set as +150 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 10 illustrates results of the examination. As illustrated in part (b) of FIG. 10, the optical image diameter largely varied in the exposure intensity range R1 as the result of the present Example. Further, image formation (printing) was performed by the image forming apparatus 100 provided with the optical head 1 of the present Example. As a result, streaks and unevenness of density were confirmed on the printed image.

### Example 4

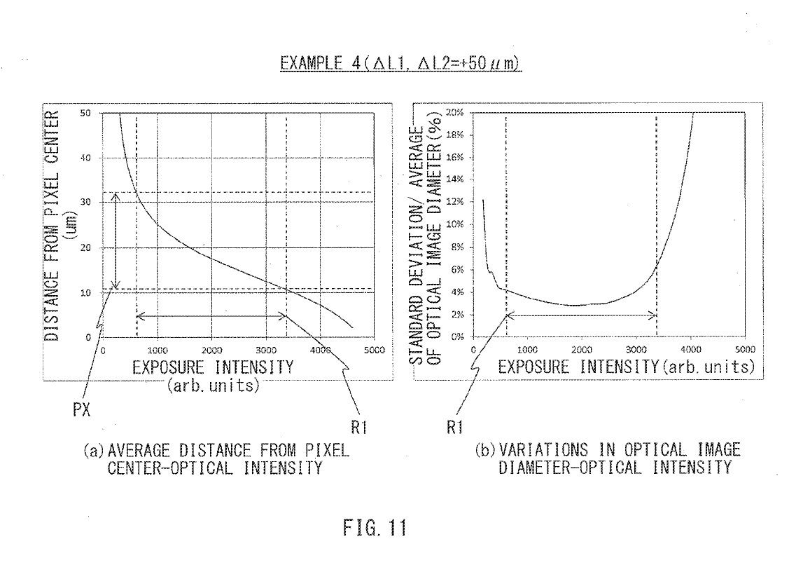

The distances ΔL1 and ΔL2 were both set as +50 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 11 illustrates results of the examination. As illustrated in part (b) of FIG. 11, the optical image diameter largely varied in the exposure intensity range R1 as the result of the present Example. More specifically, the exposure intensity range R1 involved no remarkable increase in the optical image diameter in the present Example. However, the optical image diameter increased in the vicinities of the upper limit and the lower limit of the exposure intensity range R1 compared to other part of the exposure intensity range R1. Further, image formation (printing) was performed by the image forming apparatus 100 provided with the optical head 1 of the present Example. As a result, streaks and unevenness of density were confirmed on the printed image.

### Example 5

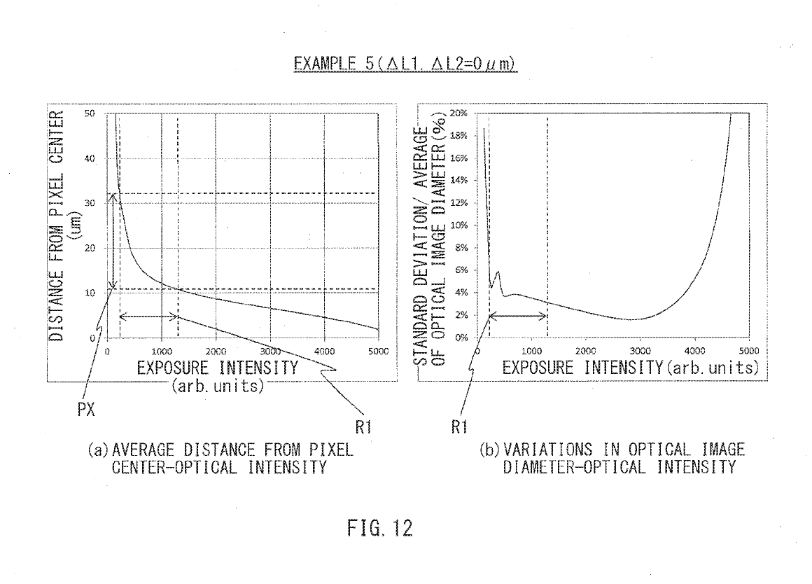

The distances ΔL1 and ΔL2 were both set as 0 (zero) μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 12 illustrates results of the examination. As illustrated in part (b) of FIG. 12, the optical image diameter largely varied in the exposure intensity range R1 (involving a remarkable increase) as the result of the present Example. Further, image formation (printing) was performed by the image forming apparatus 100 provided with the optical head 1 of the present Example. As a result, streaks and unevenness of density were confirmed on the printed image.

### Example 6

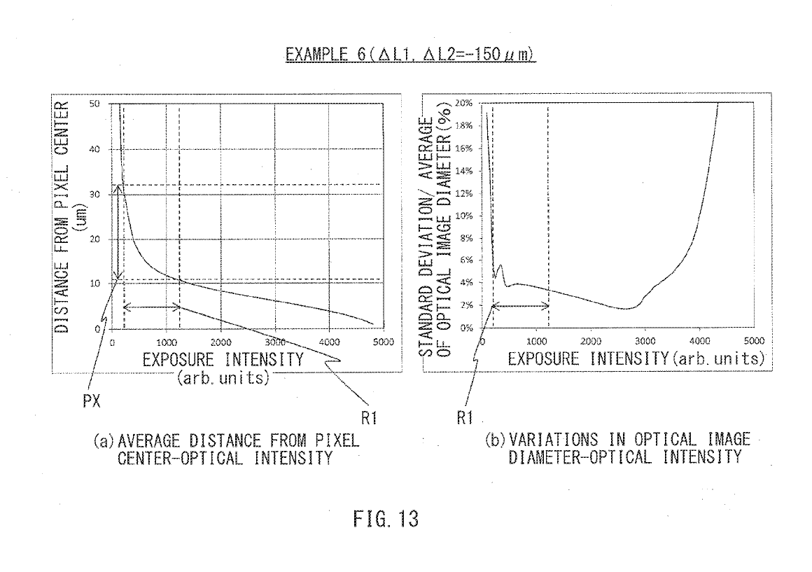

The distances ΔL1 and ΔL2 were both set as −150 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 13 illustrates results of the examination. As illustrated in part (b) of FIG. 13, the optical image diameter largely varied in the exposure intensity range R1 (involving a remarkable increase) as the result of the present Example. Further, image formation (printing) was performed by the image forming apparatus 100 provided with the optical head 1 of the present Example. As a result, streaks and unevenness of density were confirmed on the printed image.

### Example 7

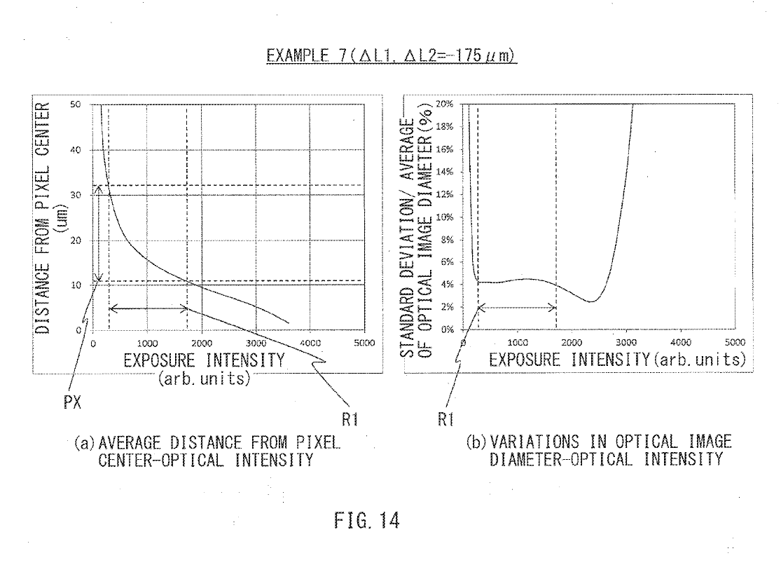

The distances ΔL1 and ΔL2 were both set as −175 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 14 illustrates results of the examination. As illustrated in part (b) of FIG. 14, the optical image diameter did not vary largely in the exposure intensity range R1 (the exposure intensity range R1 involved no remarkable increase in optical image diameter) as the result of the present Example. This was a preferable result. Further, image formation (printing) was performed by the image forming apparatus 100 provided with the optical head 1 of the present Example. As a result, no streak and no unevenness of density were confirmed on the printed image.

### Example 8

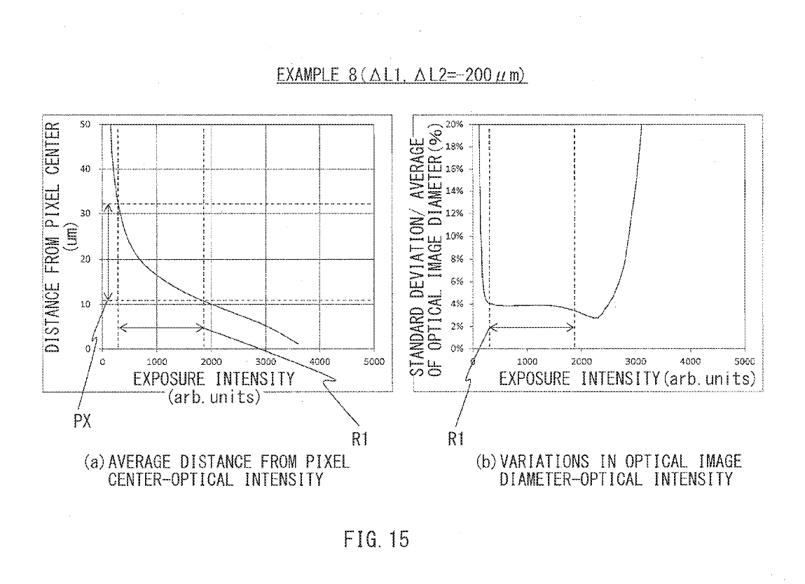

The distances ΔL1 and ΔL2 were both set as −200 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 15 illustrates results of the examination. As illustrated in part (b) of FIG. 15, the optical image diameter did not vary largely in the exposure intensity range R1 (the exposure intensity range R1 involved no remarkable increase in optical image diameter) as the result of the present Example. This was a preferable result. Further, image formation (printing) was performed by the image forming apparatus 100 provided with the optical head 1 of the present Example. As a result, no streak and no unevenness of density were confirmed on the printed image.

### Example 9

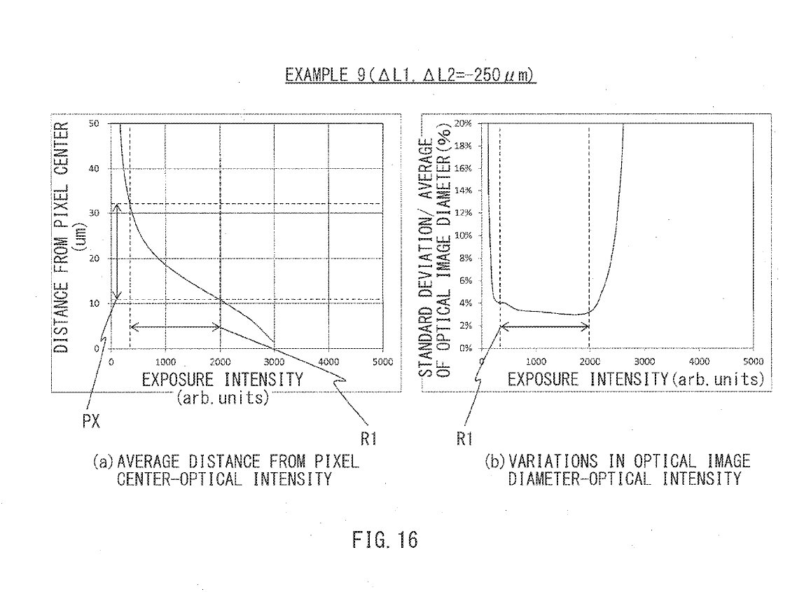

The distances ΔL1 and ΔL2 were both set as −250 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 16 illustrates results of the examination. As illustrated in part (b) of FIG. 16, the optical image diameter did not vary largely in the exposure intensity range R1 (the exposure intensity range R1 involved no remarkable increase in optical image diameter) as the result of the present Example. This was a preferable result. Further, image formation (printing) was performed by the image forming apparatus 100 provided with the optical head 1 of the present Example. As a result, no streak and no unevenness of density were confirmed on the printed image.

### Example 10

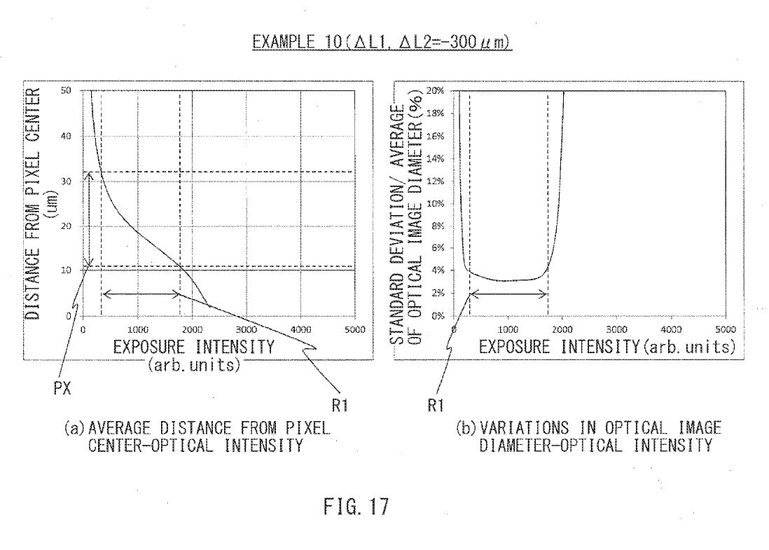

The distances ΔL1 and ΔL2 were both set as −300 μm. Except for this, conditions similar to those of Example 1 were set. The exposure intensity distribution in the X-axis direction of the LED elements 31 and the relationship between the exposure intensity and the optical image diameter of the LED elements 31 were examined. FIG. 17 illustrates results of the examination. As illustrated in part (b) of FIG. 17, the exposure intensity range R1 involved no remarkable increase in the optical image diameter in the present Example. However, the optical image diameter increased in the vicinities of the upper limit and the lower limit of the exposure intensity range R1 compared to other part of the exposure intensity range R1. Further, image formation (printing) was performed by the image forming apparatus 100 provided with the optical head 1 of the present Example. As a result, streaks and unevenness of density were confirmed on the printed image.

According to the foregoing Examples 1 to 10, it is confirmed that setting both the distances ΔL1 and ΔL2 in a range from −250 μm to −175 μm both inclusive suppresses occurrence of printing defects, on the print image printed by the image forming apparatus, such as streaks and unevenness of density.

### 3. Other Modifications

The invention has been described above referring to some example embodiment and the modifications thereof. However, the invention is not limited to the foregoing example embodiments and the modifications thereof, and is variously modifiable. For example, the foregoing example embodiment has the configuration in which the lens array 2 includes the rod lenses 21 disposed in two lines. However, the disposed positions and the number of the rod lenses are not limited thereto.

For example, a description has been given in the foregoing example embodiment referring to the image forming apparatus 100 using a primary transfer method (a direct transfer method) as an example. However, the invention is also applicable to a secondary transfer method.

Moreover, a description has been given in the foregoing example embodiment referring to the image forming apparatus having a printing function as one specific but non-limiting example of the “image forming apparatus” in one embodiment of the invention. However, this is not limitative. More specifically, the invention is also applicable, for example, to an image forming apparatus that serves as a multi-function peripheral having functions such as a scanning function and a fax function in addition to the printing function, for example.

Furthermore, the invention encompasses any possible combination of some or all of the various embodiments and the modifications described herein and incorporated herein.

It is possible to achieve at least the following configurations from the above-described example embodiments of the invention.

[1]

An exposure unit that performs exposure of an image supporting member, the exposure unit including:

a light-emitting element array including a plurality of light-emitting elements that are disposed in a first direction and each emit a light beam; and

a lens array that faces the light-emitting element array in a second direction that is orthogonal to the first direction, and focuses the light beams emitted from the respective light-emitting elements, wherein

the following expressions (1) and (2) are satisfied:

175 μm≦L0−L1≦250 μm (1)

175 μm≦L0−L2≦250 μm (2)

where L0 is a focal distance of the lens array in which a contrast becomes maximum, the contrast being determined from a light amount distribution in the first direction of any of the light beams focused by the lens array, L1 is a distance from the lens array to the light-emitting element array, and L2 is a distance from the lens array to the image supporting member.

[2]

The exposure unit according to [1], wherein the lens array includes a plurality of rod lenses each having an aperture half-angle that is substantially from 10 degrees to 15 degrees both inclusive and having a refractive index distribution in a diameter direction of the rod lens itself.

[3]

The exposure unit according to [1], wherein the lens array includes a plurality of rod lenses each having an aperture half-angle that is substantially 12 degrees and having a refractive index distribution in a diameter direction.

[4]

The exposure unit according to [2] or [3], wherein the rod lenses each have a radius that is from about 0.14 millimeters to about 0.16 millimeters both inclusive, a height that is from about 4.2 millimeters to about 4.4 millimeters both inclusive, and a focal distance that is from about 2.2 millimeters to about 2.5 millimeters both inclusive.

[5]

An image forming unit provided with the exposure unit according to any one of [1] to [4].

[6]

An image forming apparatus provided with the exposure unit according to any one of [1] to [4].

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. An exposure unit that performs exposure of an image supporting member, the exposure unit comprising:
a light-emitting element array including a plurality of light-emitting elements that are disposed in a first direction and each emit a light beam; and
a lens array that faces the light-emitting element array in a second direction that is orthogonal to the first direction, and focuses the light beams emitted from the respective light-emitting elements, wherein
the following expressions (1) and (2) are satisfied:
175 μm≦L0−L1≦250 μm (1)
175 μm≦L0−L2≦250 μm (2)
where L0 is a focal distance of the lens array in which a contrast becomes maximum, the contrast being determined from a light amount distribution in the first direction of any of the light beams focused by the lens array, L1 is a distance from the lens array to the light-emitting element array, and L2 is a distance from the lens array to the image supporting member.

2. The exposure unit according to claim 1, wherein the lens array includes a plurality of rod lenses each having an aperture half-angle that is substantially from 10 degrees to 15 degrees both inclusive and having a refractive index distribution in a diameter direction of the rod lens itself.

3. The exposure unit according to claim 1, wherein the lens array includes a plurality of rod lenses each having an aperture half-angle that is substantially 12 degrees and having a refractive index distribution in a diameter direction.

4. The exposure unit according to claim 2, wherein the rod lenses each have a radius that is from about 0.14 millimeters to about 0.16 millimeters both inclusive, a height that is from about 4.2 millimeters to about 4.4 millimeters both inclusive, and a focal distance that is from about 2.2 millimeters to about 2.5 millimeters both inclusive.

5. An image forming unit provided with an exposure unit that performs exposure of an image supporting member, the exposure unit comprising:
a light-emitting element array including a plurality of light-emitting elements that are disposed in a first direction and each emit a light beam; and
a lens array that faces the light-emitting element array in a second direction that is orthogonal to the first direction, and focuses the light beams emitted from the respective light-emitting elements, wherein
the following expressions (1) and (2) are satisfied:
175 μm≦L0−L1≦250 μm (1)
175 μm≦L0−L2≦250 μm (2)
where L0 is a focal distance of the lens array in which a contrast becomes maximum, the contrast being determined from a light amount distribution in the first direction of any of the light beams focused by the lens array, L1 is a distance from the lens array to the light-emitting element array, and L2 is a distance from the lens array to the image supporting member.

6. An image forming apparatus provided with an exposure unit that performs exposure of an image supporting member, the exposure unit comprising:
a light-emitting element array including a plurality of light-emitting elements that are disposed in a first direction and each emit a light beam; and
a lens array that faces the light-emitting element array in a second direction that is orthogonal to the first direction, and focuses the light beams emitted from the respective light-emitting elements, wherein
the following expressions (1) and (2) are satisfied:
175 μm≦L0−L1≦250 μm (1)
175 μm≦L0−L2≦250 μm (2)
where L0 is a focal distance of the lens array in which a contrast becomes maximum, the contrast being determined from a light amount distribution in the first direction of any of the light beams focused by the lens array, L1 is a distance from the lens array to the light-emitting element array, and L2 is a distance from the lens array to the image supporting member.
